(19) United States
(12) Patent Application Publication
(10) Pub. No.: US 2025/0227764 A1
(43) Pub. Date: Jul. 10, 2025

(54) HANDLING OF RANDOM ACCESS PARTITIONS AND PRIORITIES

(71) Applicant: Telefonaktiebolaget LM Ericsson (publ), Stockholm (SE)

(72) Inventors: Mattias BERGSTRÖM, Singapore (SG); Luca FELTRIN, Solna (SE); Henrik ENBUSKE, Stockholm (SE)

(21) Appl. No.: 18/853,374

(22) PCT Filed: Apr. 25, 2023
(86) PCT No.: PCT/IB2023/054246

§ 371 Date: Oct. 1, 2024

Related U.S. Application Data
(60) Provisional application No. 63/334,389, filed on Apr. 25, 2022.

(51) Int. Cl. H04W 74/0833

(52) U.S. Cl. CPC H04W 74/0833

(57) ABSTRACT

A communication device can determine a plurality of random access (“RA”) partitions configured by a network node in a communications network. The communication device can further determine one or more features associated with each of the plurality of RA partitions. The communication device can determine a set of triggered features that includes one or more features the communication device intends to use to perform a RA procedure to connect to the network node. The communication device can select a RA partition of the plurality of RA partitions based on a priority associated with a feature of the RA partition or a priority associated with a feature of another RA partition of the plurality RA partitions. The communication device can perform the RA procedure using the RA partition.

### TECHNICAL FIELD

The present disclosure is related to wireless communication systems and more particularly to handling of random access partitions and priorities.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

Random access (“RA”) partitioning is described below. For some features there is a need for the UE to provide an indication to the network already in the random access procedure. For example, a UE may need to indicate that the UE is of a certain type or that the UE wants to apply a feature. It is discussed in 3GPP that a UE of reduced capabilities (sometimes called RedCap UE) may need to indicate to the network during the random access procedure that the UE is a RedCap UE rather than a non-RedCap UE. Another example of such a feature is an indication from the UE whether the UE wants to use a Small Data Transmission (“SDT”) feature.

To provide such an indication during the random access procedure, it is discussed that the Random Access resources should be partitioned so that one partition can be dedicated to RedCap UEs and another for non-RedCap UEs.

The system may support several features which require indications during the random access procedure. For example, both support RedCap and SDT. That means that there will be several partitions to indicate combinations of features. Examples of these partitions include: one partition for non-RedCap UEs which do not want to apply SDT; one partition for non-RedCap UEs which do want to apply SDT; one partition for RedCap UEs which do not want to apply SDT; and one partition for RedCap UEs which do want to apply SDT.

A partition of a RA resources may be that there is one time-frequency RA resource which is dedicated to one feature (or combination of features), and another time-frequency RA resources which is dedicated to another feature (or combination of features). Another possibility is that one set of preambles within a RA resource is dedicated to one feature (or combination of features) and another set of preambles within a RA resource which are dedicated to another feature (or another combination of features).

The 3^{rd} Generation Partnership Project (′3GPP″) has agreed that there should be a prioritization among the features for which preamble partitions can be associated to, for example, a priority for RedCap and another priority for SDT.

### SUMMARY

According to some embodiments, a method of operating a communication device is provided. The method includes determining a plurality of random access (“RA”) partitions configured by a network node in a communications network. The method further includes determining one or more features associated with each of the plurality of RA partitions. The method further includes determining a set of triggered features that includes one or more features the communication device intends to use to perform a RA procedure to connect to the network node. The method further includes selecting a RA partition of the plurality of RA partitions based on a priority associated with a feature of the RA partition or a priority associated with a feature of another RA partition of the plurality RA partitions. The method further includes performing the RA procedure using the RA partition.

According to other embodiments, another method of operating a communication device is provided. The method includes determining a plurality of random access (“RA”) partitions configured by a network node in a communications network. The method further includes determining one or more features associated with each of the plurality of RA partitions. The method further includes determining a set of triggered features that includes one or more features the communication device intends to use to perform a RA procedure to connect to the network node. The method further includes determining that none of the plurality of RA partitions are applicable to performing the RA procedure based on the set of triggered features and the one or more features associated with each of the plurality of RA partitions. The method further includes, responsive to determining that none of the plurality of RA partitions are applicable to performing the RA procedure, performing at least one of: performing the RA procedure using a RA resource that is not associated with any feature; adjusting the set of triggered features; and classifying a cell of the network node as barred and avoiding connecting and/or camping on the cell.

According to other embodiments, a method of operating a network node in a communications network is provided. The method includes determining a plurality of random access (“RA”) partitions configured by the network node. The method further includes determining one or more features associated with each of the plurality of RA partitions. The method further includes determining a priority associated with each of the one or more features. The method further includes transmitting a message to a communication device indicating the plurality of RA partitions, the one or more features associated with each of the plurality of RA partitions, and the priority associated with each of the one or more features. The method further includes performing a RA procedure with the communication device using one of the RA partitions of the plurality of RA partitions, the RA partition selected by the communication device.

Certain embodiments may provide one or more of the following technical advantages. In some embodiments, efficient and well-defined UE behavior can be achieved for how to select RA partitions. In additional or alternative embodiments, a network can configure the partitions and the feature priorities in a suitable manner (resulting in wanted UE behavior).

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIG. 2 is table illustrating an example of error metrics computed for different available partitions in accordance with some embodiments;

FIG. 3 is a table illustrating an example of iterations of an iterative procedure for selecting a partition in accordance with some embodiments;

FIGS. 4-5 are flow charts illustrating examples of operations performed by a communication device in accordance with some embodiments;

FIG. 6 is a flow chart illustrating an example of operations performed by a network node in accordance with some embodiments;

FIG. 7 is a block diagram of a communication system in accordance with some embodiments;

FIG. 8 is a block diagram of a user equipment in accordance with some embodiments

FIG. 9 is a block diagram of a network node in accordance with some embodiments;

FIG. 10 is a block diagram of a host computer communicating with a user equipment in accordance with some embodiments;

FIG. 11 is a block diagram of a virtualization environment in accordance with some embodiments; and

FIG. 12 is a block diagram of a host computer communicating via a base station with a user equipment over a partially wireless connection in accordance with some embodiments in accordance with some embodiments.

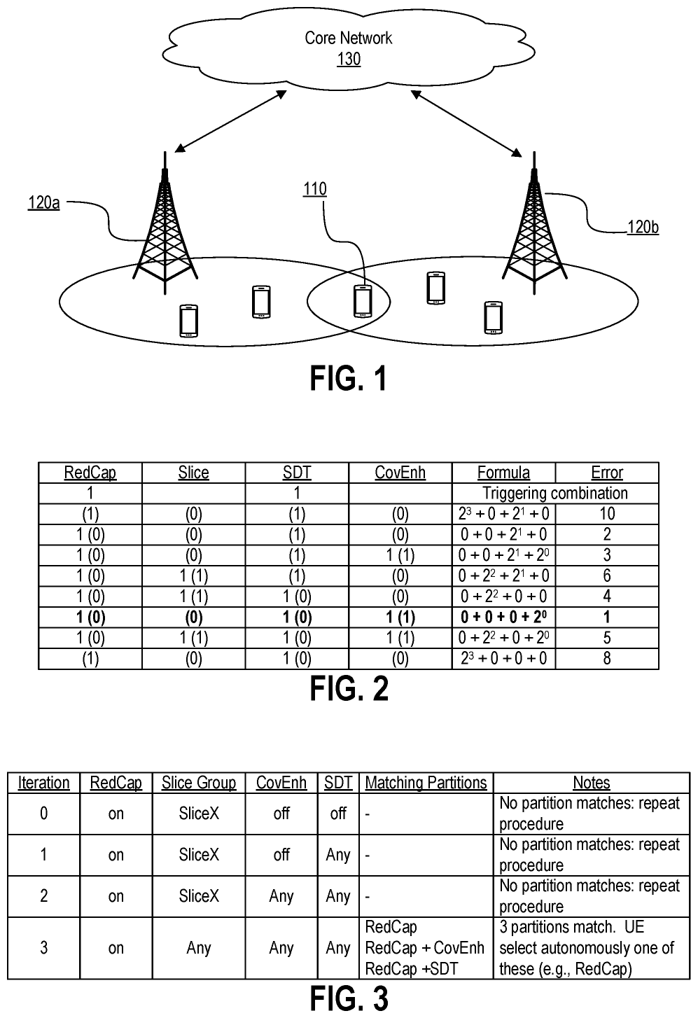

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

There currently exist certain challenges. For example, selecting which preamble partition a UE uses can be challenging considering the priorities are not well defined. How the partitions and their priorities should be used needs to be specified to ensure a consistent UE behavior. Otherwise, it may lead to one UE selecting one partition in one way while another UE (in the same situation) selects another partition.

In some examples, if the UE does not find any partition which the UE can be used there is no defined UE behavior. This may result in the UE getting stuck and not being able to get out of this situation, which can result in service interruption.

Certain aspects of the disclosure and their embodiments may provide solutions to these or other challenges. Various embodiments are described herein that provide a procedure for how the UE selects preamble partitions considering which features the partitions are associated to, and which features the UE intends to indicate, as well as priorities for the different features.

In additional or alternative embodiments, a set of possible operations are described which could be applied by the UE if the UE is not able to find any partition which the UE can use (considering the features which the UE wants to indicate (referred herein as the triggered features) and the priorities).

In some embodiments herein, the term feature combination is used to refer to one or more features which can be applied by a communication device (also referred to herein as a user equipment (“UE”)). The word “feature” here should be understood in a broad sense. For example, a feature may be that the UE is a certain type of UE (e.g., that the UE has reduced capabilities (also referred to herein as a RedCap UE). Some features may be a certain procedure which the UE applies. In some examples, the features include a Small Data Transmission (“SDT”), which is an approach the UE can apply to transmit (or receive) data to the network. In additional or alternative examples, the features include a Coverage Enhancement (“CovEnh”) feature which is an approach to perform the random access (“RA”) procedure to make sure that coverage is extended (e.g., by performing repetitions of some messages during the RA procedure). Some features include that the UE intends to get associated with a certain network resource (e.g., as a network slice).

In some embodiments herein, the term RA partition is used to refer to a set of preambles which can be mapped to a feature combination. The network can indicate which features a certain partition is associated with, for example, that an RA partition is associated with RedCap, while another is associated with SDT, while another is associated to the combination of RedCap and SDT. An RA partition may be referred to as a preamble partition or just partition.

In some embodiments herein, the term triggered features is used to refer to a set of features which the UE wants to indicate. For example, the UE may be a RedCap UE that wants to perform an SDT procedure to send data, in this case RedCap and SDT would both be triggered features for this attempt.

In some embodiments herein, the term applicable RA partition is used to refer to a RA partition, which the UE can use when performing this RA procedure.

In some embodiments herein, the term selected RA partition is used to refer to a partition among the applicable RA partitions, which the UE ends up using for the access attempt.

Various embodiments herein describe how a UE performs an RA procedure where there are a set of RA partitions that the UE can choose between to indicate triggered features, and where the UE also considers a priority for the features.

In some embodiments, the UE acquires a set of RA partitions from the network. The UE can further acquire a mapping where each RA partition is mapped to a feature combination. The features can have an associated priority value. These information elements (e.g., the set of RA partitions, the mapping, and the priority value) may for example be acquired from the network, for example, via system information

In additional or alternative embodiments, the UE uses these information elements to determine a RA resource to use when performing a RA procedure. In some examples, the UE determines a set of RA partitions and their associated feature combinations; determines a set of triggered features; determines the applicable RA partitions; selects one RA partition among the applicable RA partitions to use for the RA procedure considering the feature priorities; and handles failure of selecting a partition.

Embodiments associated with a UE determining applicable RA partitions are described below.

In some embodiments, the UE considers an RA partition to be applicable for the random access attempt only if the set of features that the RA partition is associated to includes (at least) all triggered features. This can result in a partition being considered applicable even if it includes non-triggered features (in addition to all of the triggered features). In some examples, one benefit of this approach is that the UE will ensure that the partitions that the UE selects will indicate all features that have been triggered.

In some examples, the triggered features include RedCap and SDT. The Feature priorities (lower number meaning high priority) can include: 1) RedCap; 2) Slice X; 3) SDT; and 4) Coverage enhancements. The partitions and their mapped feature combinations can include: 1) None (a RA partition not mapped to any of the features); 2) RedCap; 3) RedCap+CovEnh; 4) RedCap+Slice X; 5) RedCap+SDT+Slice X; 6) RedCap+SDT+CovEnh; 7) RedCap+SDT+CovEnh+Slice X; and 8) SDT. In this example, the UE can consider the applicable RA partitions to be 5, 6, and 7 because these three partitions are all mapping to (at least) both triggered features (both RedCap and SDT). But, for example, partition 3 is not considered an applicable RA partition because it is not mapped to SDT.

In additional or alternative embodiments, the UE considers a partition applicable if only triggered features are mapped to this partition. If on the other hand, a partition is also associated with a non-triggered feature, that partition will not be considered applicable. In some examples, one benefit of this approach is that it ensures that the UE will not indicate a non-triggered feature.

In some examples, the triggered features include RedCap and SDT. The Feature priorities (lower number meaning high priority) can include: 1) RedCap; 2) Slice X; 3) SDT; and 4) Coverage enhancements. The partitions and their mapped feature combinations can include: 1) None (a RA partition not mapped to any of the features); 2) RedCap; 3) RedCap+CovEnh; 4) RedCap+Slice X; 5) RedCap+SDT+Slice X; 6) RedCap+SDT+CovEnh; 7) RedCap+SDT+CovEnh+Slice X; and 8) SDT. In this example, the UE would consider the applicable RA partitions to be 2 and 8 since these partitions are associated with only triggered features. Partition 3 for example is not considered applicable since it, in addition to the triggered features, is also associated to CovEnh. And similarly partition 5 is not applicable since it is also associated with Slice X.

Embodiments associated with a UE selecting one RA partition among the applicable RA partitions are described below.

In some embodiments, the UE will select a RA partition among the applicable RA partitions to use for the RA procedure by selecting the partition which, in addition to the triggered features, also maps to the (non-triggered) feature with the lowest (or highest) priority.

In some examples, the UE may have determined (as described in the examples above) that the applicable partitions include: 5) RedCap+SDT+Slice X; and 6) RedCap+SDT+CovEnh. In this example, the UE would select partition 6 since CovEnh has lower (or higher) priority than Slice X. In some examples, one benefit of this approach is that the network may set the priorities such that lowest (or highest) priority is given to a feature which it matters least if the UE indicates in addition to the triggered features.

In additional or alternative examples, there are more than one partition which, in addition to the triggered features, also maps to the (non-triggered) lowest (or highest) priority feature. In this case the UE may need to apply a more elaborate selection process. One such, more elaborate, selection process is that the UE selects the partition which (in addition to the non-triggered features) maps to the lowest (or highest) priority feature and also maps to fewest other features. To explain further, consider an example in which the UE has determined that the applicable partitions include: 5) RedCap+SDT+Slice X; 6) RedCap+SDT+CovEnh; and 7) RedCap+SDT+CovEnh+Slice X. According to the configured priorities, CovEnh is the lowest (or highest) priority feature. The UE would hence select between partition 6 and 7. However, as also explained, since in this example there are more than one partition mapping to CovEnh, the UE must select one of these partitions. And in one approach the UE selects the partition which maps to the lowest (or highest) priority feature which also maps to the fewest number of other features. Which, in this example, would be partition number 6.

In additional or alternative examples, the lowest (or highest) priority feature (CovEnh in the above example) does not map to any of the applicable partitions. In that case the UE may consider the second lowest (or highest) priority feature, and then re-apply the selection process above to determine which of the applicable partitions to select. For example, the UE may determine that the applicable partitions include: 2) RedCap; and 3) SDT+Slice X. Since CovEnh is the lowest priority feature but that doesn't may to any partition, the UE would consider the second lowest priority feature, and in this example the UE would end up selecting slice 3 since the second lowest priority (non-triggered feature) is Slice X.

A Value N-based selection algorithm is described below.

In some embodiments, the UE determines a value N for each partition. This value N is the sum of the priority values for all features that the partition is associated with. If this is done in the example above, the UE would end up with these numbers:

$$5 ) RedCap ( Priority value 1 ) + SDT ( Priority value 3 ) + Slice X ( Priority value 2 ) = 6 ;$$

$$6 ) RedCap ( Priority value 1 ) + SDT ( Priority value 3 ) + CovEnh ( Priority value 4 ) = 8 ;$$

$$7 ) RedCap ( Priority value 1 ) + SDT ( Priority value 3 ) + CovEnh ( Priority value 4 ) + Slice X ( Priority value 2 ) = 10$$

In this embodiment, the UE selects the partition with the highest (or lowest) value N which in this case is partition number 7.

In additional or alternative embodiments, the UE determines a value N for each partition. This value N is the sum of the power of 2 to the position in the priority list for all features that the partition is associated with. If this is done in the example above, the UE would end up with these numbers:

$$5 ) RedCap ( Priority value 0 ) + SDT ( Priority value 2 ) + Slice X ( Priority value 1 ) = {2}^{0} + {2}^{2} + {2}^{1} = 7 ;$$

$$6 ) RedCap ( Priority value 0 ) + SDT ( Priority value 2 ) + CovEnh ( Priority value 3 ) = {2}^{0} + {2}^{2} + {2}^{3} = 13 ;$$

$$7 ) RedCap ( Priority value 0 ) + SDT ( Priority value 2 ) + CovEnh ( Priority value 3 ) + Slice X ( Priority value 1 ) = {2}^{0} + {2}^{2} + {2}^{3} + {2}^{1} = 15$$

In this embodiment, the UE selects the partition with the highest (or lowest) value N which in this case is partition number 7.

In additional or alternative embodiments, the UE selects the partition with the highest priority features. In some examples, the UE determines the applicable partitions include: 2) RedCap; and 8) SDT. The UE would according to this embodiment select the RedCap partition since RedCap has higher priority than SDT.

In additional or alternative embodiments, there are multiple applicable partitions and the highest priority feature maps is associated to more than one partition. In some examples, the RedCap, SDT and Slice X are triggered features. That could result in a scenario where these example partitions are applicable: 1) SDT+Slice X; 2) RedCap+SDT; 3) RedCap+Slice X; and 4) RedCap+SDT+Slice X.

The UE may in these cases need to consider the priorities for multiple features. For example, the UE would by only considering RedCap not be able to select one partition (since 2, 3 and 4 all map to RedCap) the UE would then need to consider the second highest priority feature (Slice X), but also that would still make both partition 3 and 4 candidates. The UE would then move on to the third highest priority feature (SDT) to finally determine that partition 4 above is the one to select. (Note: If partition 4 in the above example was not configured, the UE would end up selecting partition 3, which does not contain all triggered features).

In some embodiments, an error based procedure is used to select the partition. In this approach there is no constraint on the UE indicating only triggered features or not indicating non-triggered features. The UE determines the best partition case by case. In this approach the set of applicable partitions is equal to the set of all the configured partitions and the selected partition is determined as described below.

The UE starts by calculating a metric “error” for each available partition. This metric is intended to measure how different a certain partition is compared to the triggering feature combination.

The error metric is calculated as the sum of terms referring to each feature when the values of the considered and targeted indication are different, and the value is two to the power of their order in the priority list.

In mathematical terms for F features in order of priority from the lowest to the highest so that i={0, 1, . . . , F−1}, the available partition under exam is represented as P={p₀, p₁, . . . p_{F-1}} and the triggering partition is represented as T={t₀, t₁, . . . , t_{F-1}} the error between partition P and T is computed as

$$Error ( T , P ) = {\sum }_{i = 0}^{F - 1} {2}^{i} ( {p}_{i} {XORt}_{i} )$$

After this procedure, the UE simply selects the partition with the smaller error.

Notice that each partition will always have a unique value for its error due to mathematical properties, so the result of this procedure will always be only a single partition.

An example of the use of this procedure is described below in reference to FIG. 2.

In some examples, the triggered features include RedCap and SDT (T={0, 1, 0, 1}). The Feature priorities (number corresponds to index i lower number meaning high priority) can include: 0) Coverage Enhancements; 1) Small Data; 2) Slice X; and 3) RedCap. The partitions and their mapped feature combinations can include: 1) None (a RA partition not mapped to any of the features); 2) RedCap; 3) RedCap+CovEnh; 4) RedCap+Slice X; 5) RedCap+SDT+Slice X; 6) RedCap+SDT+CovEnh; 7) RedCap+SDT+CovEnh+Slice X; and 8) SDT.

The error metric for each available partition is computed as in the table illustrated in FIG. 2 (number in parenthesis is the result of the XOR operation). The UE will select the partition for RedCap+Small Data+Coverage Enhancements

Embodiments associated with an iterative procedure are described below.

In some embodiments, the UE starts by considering the triggered features as the “matching criterion”, and checks if the partition as it is, is configured. If it is, the UE can select the exact matching partition and terminate the procedure.

If it is not present, the UE removes the constraint on the lowest prioritized feature and checks again if there are matching partitions (exact match for the features which still have a constraint, and any value for the features which have no constraint in the current iteration).

If a match is still not present, the UE repeats the operations above after removing the constraint on the next lowest prioritized feature.

Eventually one or more partitions will be matching the criterion, and the UE can then select the final partition using one of the previously described embodiments or just let the UE autonomously select one of these partitions as they are all equivalent in terms of difference from the triggered feature combination.

In some examples, the feature priorities (from highest to lowest priority) includes: RedCap→Slice X→Coverage Enhancements→Small Data. The triggering combination can include: RedCap+Slice X. The partitions and their mapped feature combinations can include: 1) None; 2) RedCap; 3) RedCap+CovEnh; 4) RedCap+SDT; and 5) SliceX+CovEnh.

FIG. 3 illustrates an example of the iterative procedure.

In some embodiments, there can be situations where the UE determines that no RA partition is allowable considering the triggered features. In some examples, the triggered features include: RedCap and SDT. The partitions and their mapped feature combinations include: 1) RedCap+CovEnh; and 2) SDT+Slice X.

In this example, partition 2 is not applicable since it also (in addition to triggered features) is associated with CovEnh, and partition 3 is not applicable since it also (in addition to triggered features) is associated with Slice X.

In some embodiments, if the UE determines that no partition is applicable, the UE may select a RA resources which is not associated to any feature, meaning a set of RA resources used by UEs which do not want to indicate any feature.

In additional or alternative embodiments, if the UE determines that no partition is applicable, the UE may select another set of triggered features. For example, if the RA procedure was initiated in order to perform an SDT-transmission, the UE may, if the UE is not able to find any partition which can be used when SDT is a triggered feature, attempt the RA procedure without SDT as a triggered feature.

In additional or alternative embodiments, if the UE determines that no partition is applicable, the UE may consider the cell as barred or by other means ensure that the UE does not attempt to connect to or camp on that cell. The UE may consider the cell as barred for a certain period of time, for example 300 seconds. After that period of time the UE may again consider his cell as a candidate to connect to. In version of this embodiment, the UE monitors for a change in configuration of the cell. For example, the cell may change the configuration for RA partitioning for example by adding a new partition. In this case the UE may consider the cell as a candidate to connect to again (e.g. even if the period of time has not passed yet). The UE may with this approach attempt to find another cell which the UE can connect to or camp on.

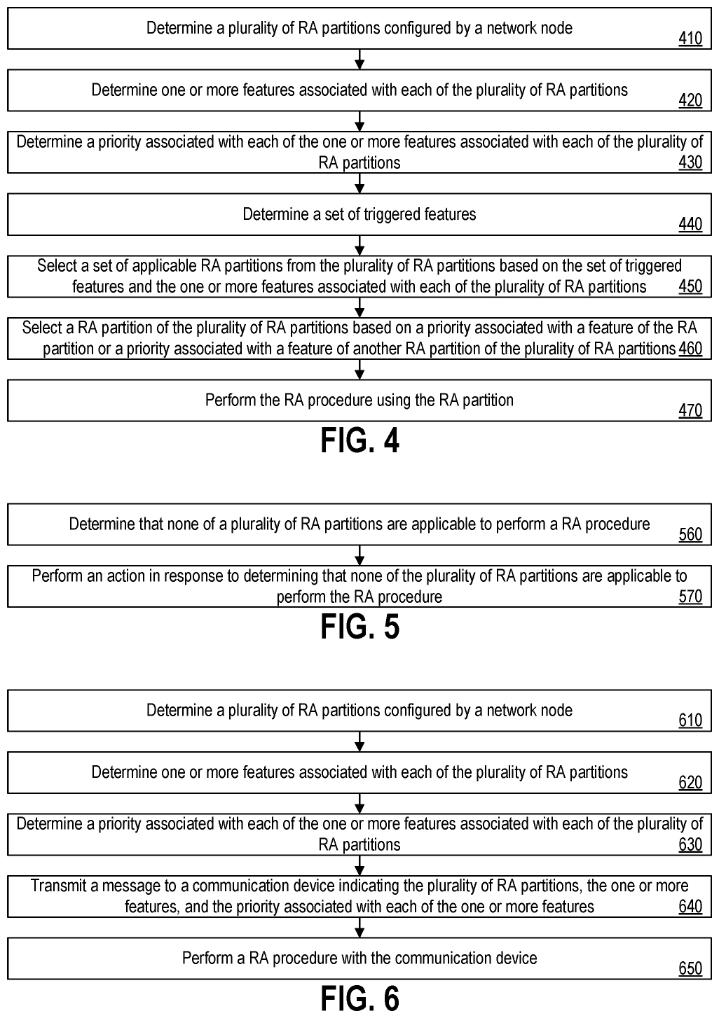

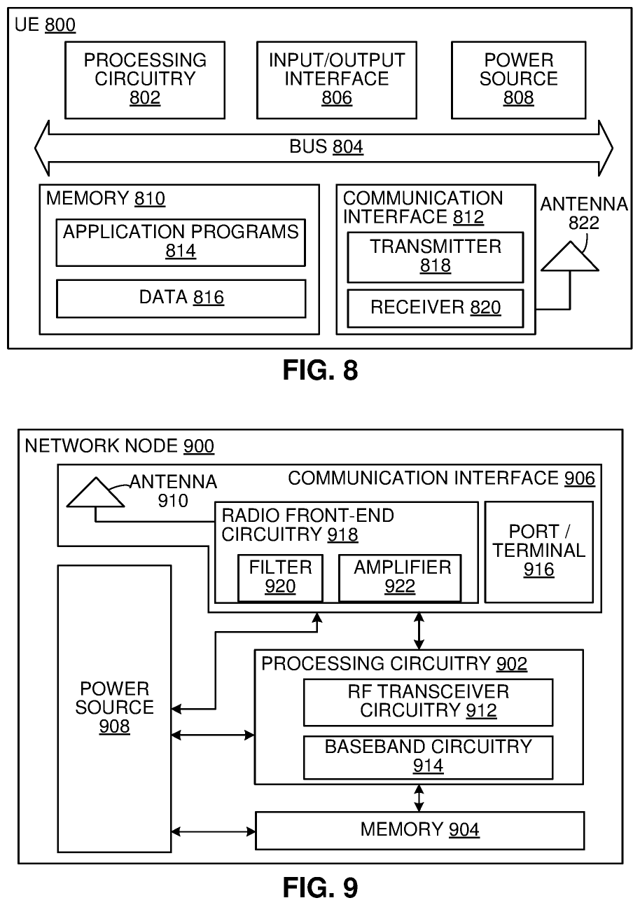

In the description that follows, while the communication device may be any of the wireless device 712A, 712B, wired or wireless devices UE 712C, UE 712D, UE 800, virtualization hardware 1104, virtual machines 1108A, 1108B, or UE 1206, the UE 800 (also referred to herein as communication device 800) shall be used to describe the functionality of the operations of the communication device. Operations of the communication device 800 (implemented using the structure of the block diagram of FIG. 8) will now be discussed with reference to the flow charts of FIGS. 4-5 according to some embodiments of inventive concepts. For example, modules may be stored in memory 810 of FIG. 8, and these modules may provide instructions so that when the instructions of a module are executed by respective communication device processing circuitry 802, processing circuitry 802 performs respective operations of the flow charts.

FIG. 4 illustrates operations performed by a communication device to handle random access partitions and priorities.

At block 410, processing circuitry 802 determines a plurality of RA partitions configured by a network node.

At block 420, processing circuitry 802 determines one or more features associated with each of the plurality of RA partitions.

At block 430, processing circuitry 802 determines a priority associated with each of the one or more features associated with each of the plurality of RA partitions. In some embodiments, determining the priority associated with each of the one or more features associated with each RA partition of the plurality of RA partitions includes receiving an indication of the priority associated with at least one of the one or more features associated with each RA partition of the plurality of RA partitions.

At block 440, processing circuitry 802 determines a set of triggered features. In some embodiments, the set of triggered features includes one or more features the communication device intends to use to perform a RA procedure to connect to the network node.

At block 450, processing circuitry 802 selects a set of applicable RA partitions from the plurality of RA partitions based on the set of triggered features and the one or more features associated with each of the plurality of RA partitions. In some embodiments, selecting the set of applicable RA partitions includes selecting the set of applicable RA partitions from the plurality of RA partitions based on each RA partition of the set of applicable RA partitions comprising the set of triggered features. In additional or alternative embodiments, selecting the set of applicable RA partitions includes selecting the set of applicable RA partitions from the plurality of RA partitions based on each RA partition of the set of applicable RA partitions comprising only features in the set of triggered features.

At block 460, processing circuitry 802 selects a RA partition of the plurality of RA partitions based on a priority associated with a feature of the RA partition. In some embodiments, selecting the RA partition includes selecting the RA partition from the set of applicable RA partitions based on the priority associated with the feature of the RA partition.

In additional or alternative embodiments, selecting the RA partition from the plurality of RA partitions includes determining a priority of a first feature that is associated with the RA partition and selecting the RA partition from the plurality of RA partitions based on the priority of the first feature relative to a priority of a second feature of another RA partition of the plurality of RA partitions. The first feature and the second feature can be in the set of triggered features.

In additional or alternative embodiments, selecting the RA partition from the plurality of RA partitions includes determining a priority of a first feature that is associated with the RA partition and selecting the RA partition from the plurality of RA partitions based on a priority of the first feature relative to a priority of a second feature of another RA partition of the plurality of RA partitions. The first feature and the second feature can be absent from the set of triggered features.

In additional or alternative embodiments, selecting the RA partition from the plurality of RA partitions includes determining a total priority associated with each RA partition of the plurality of RA partitions based on a priority associated with each of the one or more features associated with each RA partition of the plurality of RA partitions and selecting the RA partition based on a total priority of the RA partition.

In additional or alternative embodiments, selecting the RA partition from the plurality of RA partitions includes determining a difference between the one or more features associated with the RA partition and the set of triggered features; and selecting the RA partition based on the difference.

In additional or alternative embodiments, selecting the RA partition from the plurality of RA partitions includes generating a second set of triggered features based on the set of triggered features; adjusting the second set of triggered features until one RA partition of the plurality of RA partitions is associated with one or more features that match the second set of triggered features; and selecting the second RA partition as the RA partition.

At block 470, processing circuitry 802 performs the RA procedure using the RA partition.

FIG. 5 illustrates operations performed by a communication device in which the communication device fails to find an appliable RA partition. Although these operations are described as separate from the operations of FIG. 4, some embodiments include a combination of the operations of FIGS. 4-5.

At block 560, processing circuitry 802 determines that none of a plurality of RA partitions are applicable to perform a RA procedure.

At block 570, processing circuitry 802 performs an action in response to determining that none of the plurality of RA partitions are applicable to perform the RA procedure. In some embodiments, processing circuitry 802 performs the RA procedure using a RA resource that is not associated with any feature. In additional or alternative embodiments, processing circuitry 802 adjusting the set of triggered features. In additional or alternative embodiments, In additional or alternative embodiments, processing circuitry 802 classifies a cell of the network node as barred and avoiding connecting and/or camping on the cell.

Various operations from the flow charts of FIGS. 4-5 may be optional with respect to some embodiments of communication devices and related methods.

In the description that follows, while the network node may be any of the network node 710A, 710B, core network node 708, network node 900, virtualization hardware 1104, virtual machines 1108A, 1108B, or network node 1204, the network node 900 shall be used to describe the functionality of the operations of the network node. Operations of the network node 900 (implemented using the structure of the block diagram of FIG. 9) will now be discussed with reference to the flow chart of FIG. 6 according to some embodiments of inventive concepts. For example, modules may be stored in memory 904 of FIG. 9, and these modules may provide instructions so that when the instructions of a module are executed by respective network node processing circuitry 902, processing circuitry 902 performs respective operations of the flow chart.

FIG. 6 illustrates operations performed by a network node to handle random access partitions and priorities.

At block 610, processing circuitry 902 determines a plurality of RA partitions configured by a network node.

At block 620, processing circuitry 902 determines one or more features associated with each of the plurality of RA partitions.

At block 630, processing circuitry 902 determines a priority associated with each of the one or more features associated with each of the plurality of RA partitions. In some embodiments, determining the priority associated with each of the one or more features includes determining the priority associated with each of the one or more features based on a preference for the communication device to select a first RA partition of the plurality of RA partitions over a second partition of the plurality of RA partitions.

At block 640, processing circuitry 902 transmits, via communication interface 906, a message to a communication device indicating the plurality of RA partitions, the one or more features, and the priority associated with each of the one or more features.

At block 650, processing circuitry 902, performs a RA procedure with the communication device.

Various operations from the flow chart of FIG. 6 may be optional with respect to some embodiments of network entities and related methods.

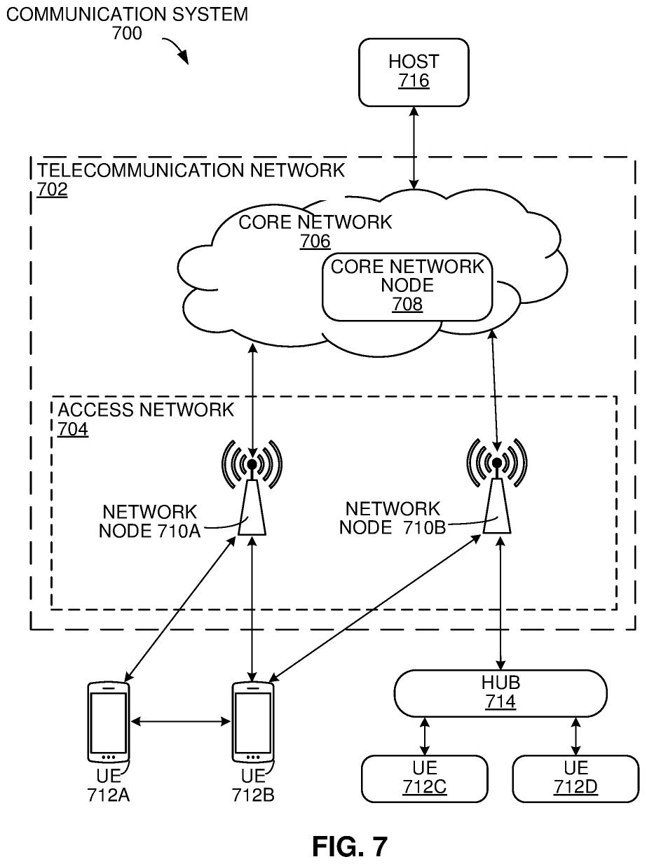

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3^{rd} Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

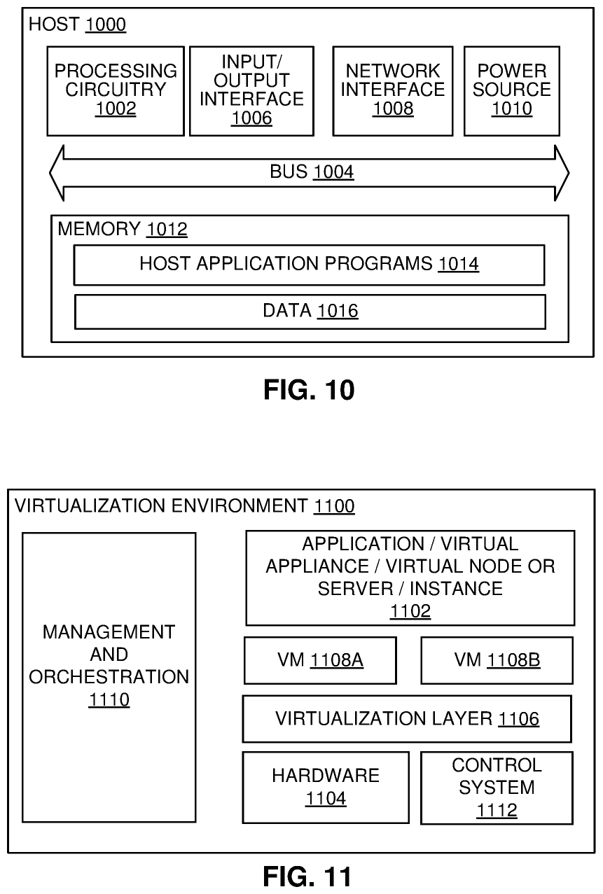

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

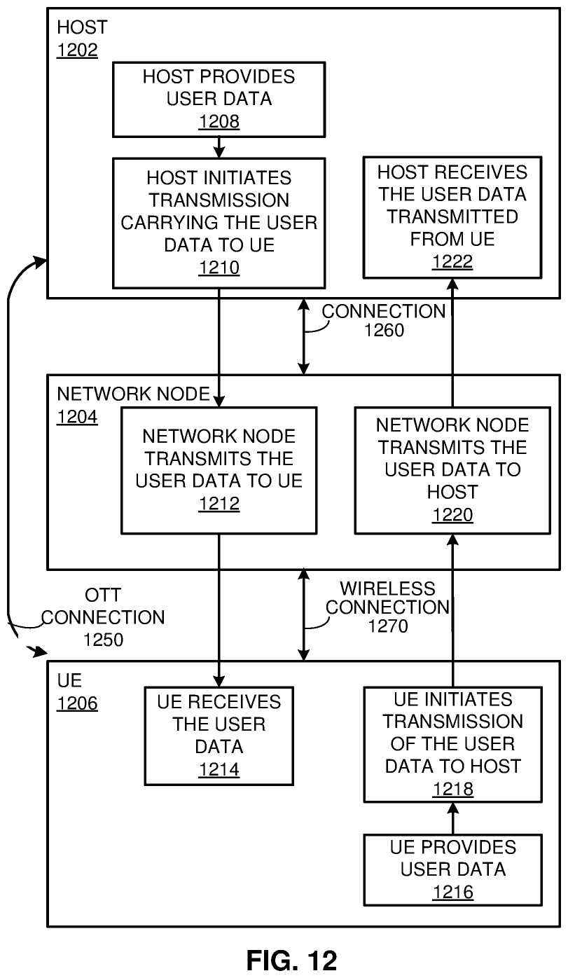

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, the teachings of these embodiments may define how a UE selects a RA partition, which can result in an expected behavior that can be manipulated and predicted by the network.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method of operating a communication device, the method comprising:
determining a plurality of random access, RA, partitions configured by a network node in a communications network;
determining one or more features associated with each of the plurality of RA partitions;
determining a set of triggered features that includes one or more features the communication device intends to use to perform a RA procedure to connect to the network node;
selecting a RA partition of the plurality of RA partitions based on a priority associated with a feature of the RA partition or a priority associated with a feature of another RA partition of the plurality RA partitions; and
performing the RA procedure using the RA partition.

2. The method of claim 1, further comprising:
selecting a set of applicable RA partitions from the plurality of RA partitions based on the set of triggered features and the one or more features associated with each of the plurality of RA partitions,
wherein selecting the RA partition comprises selecting the RA partition from the set of applicable RA partitions based on the priority associated with the feature of the RA partition or a priority associated with a feature of another RA partition of the set of applicable RA partitions.

3. The method of claim 2, wherein selecting the set of applicable RA partitions comprises selecting the set of applicable RA partitions from the plurality of RA partitions based on each RA partition of the set of applicable RA partitions comprising the set of triggered features.

4. The method of claim 2, wherein selecting the set of applicable RA partitions comprises selecting the set of applicable RA partitions from the plurality of RA partitions based on each RA partition of the set of applicable RA partitions comprising only features in the set of triggered features.

5. The method of claim 1, further comprising:
determining a priority associated with each of the one or more features associated with each RA partition of the plurality of RA partitions.

6. The method of claim 5, wherein determining the priority associated with each of the one or more features associated with each RA partition of the plurality of RA partitions comprises receiving an indication of the priority associated with at least one of the one or more features associated with each RA partition of the plurality of RA partitions.

7. The method of claim 1, wherein selecting the RA partition from the plurality of RA partitions comprises:
determining a priority of a first feature that is associated with the RA partition, the first feature being in the set of triggered features; and
selecting the RA partition from the plurality of RA partitions based on the priority of the first feature relative to a priority of a second feature of another RA partition of the plurality of RA partitions, the second feature being in the set of triggered features.

8. The method of claim 1, wherein selecting the RA partition from the plurality of RA partitions comprises:
determining a priority of a first feature that is associated with the RA partition, the first feature being absent from the set of triggered features; and
selecting the RA partition from the plurality of RA partitions based on a priority of the first feature relative to a priority of a second feature of another RA partition of the plurality of RA partitions, the second feature being absent from the set of triggered features.

9. The method of claim 1, wherein selecting the RA partition from the plurality of RA partitions comprises:
determining a total priority associated with each RA partition of the plurality of RA partitions based on a priority associated with each of the one or more features associated with each RA partition of the plurality of RA partitions; and
selecting the RA partition based on a total priority of the RA partition.

10. The method of claim 1, wherein selecting the RA partition from the plurality of RA partitions comprises:
determining a difference between the one or more features associated with the RA partition and the set of triggered features; and
selecting the RA partition based on the difference.

11. The method of claim 1, wherein the RA partition is a first RA partition,
wherein the set of triggered features comprises a first set of triggered features,
wherein selecting the RA partition from the plurality of RA partitions comprises:
generating a second set of triggered features based on the first set of triggered features;
adjusting the second set of triggered features until one RA partition of the plurality of RA partitions is associated with one or more features that match the second set of triggered features; and
selecting the second RA partition as the first RA partition.

12. The method of claim 1, wherein the set of triggered features are a first set of triggered features,
the method further comprising:
determining that none of the plurality of RA partitions are applicable to performing the RA procedure based on a second set of triggered features and the one or more features associated with each of the plurality of RA partitions, the second set of triggered features including one or more features that are not included in the first set of triggered features; and
responsive to determining that none of the plurality of RA partitions are applicable, determining the first set of triggered features based on the second set of triggered features.

13. The method of claim 1, wherein the network node comprises a first network node,
wherein the plurality of RA partitions comprises a first plurality of RA partitions,
the method further comprising:
determining that none of a second plurality of RA partitions are applicable to performing a RA procedure to connect to a second network node based on the set of triggered features and one or more features associated with each of the second plurality of RA partitions; and
responsive to determining that none of the second plurality of RA partitions are applicable, classifying a cell of the second network node as barred and avoiding connecting and/or camping on the cell.

14. A method of operating a communication device, the method comprising:
determining a plurality of random access, RA, partitions configured by a network node in a communications network;
determining one or more features associated with each of the plurality of RA partitions;
determining a set of triggered features that includes one or more features the communication device intends to use to perform a RA procedure to connect to the network node;
determining that none of the plurality of RA partitions are applicable to performing the RA procedure based on the set of triggered features and the one or more features associated with each of the plurality of RA partitions; and
responsive to determining that none of the plurality of RA partitions are applicable to performing the RA procedure, performing at least one of:
performing the RA procedure using a RA resource that is not associated with any feature;
adjusting the set of triggered features; and
classifying a cell of the network node as barred and avoiding connecting and/or camping on the cell.

15. The method of claim 14, further comprising:
selecting a set of applicable RA partitions from the plurality of RA partitions based on the set of triggered features and the one or more features associated with each of the plurality of RA partitions,
wherein selecting the RA partition comprises selecting the RA partition from the set of applicable RA partitions based on the priority associated with the feature of the RA partition or a priority associated with a feature of another RA partition of the set of applicable RA partitions.

16. A method of operating a network node in a communications network, the method comprising:
determining a plurality of random access, RA, partitions configured by the network node;
determining one or more features associated with each of the plurality of RA partitions;
determining a priority associated with each of the one or more features;
transmitting a message to a communication device indicating the plurality of RA partitions, the one or more features associated with each of the plurality of RA partitions, and the priority associated with each of the one or more features; and
performing a RA procedure with the communication device using one of the RA partitions of the plurality of RA partitions, the RA partition selected by the communication device.

17. The method of claim 16, wherein determining the priority associated with each of the one or more features comprises determining the priority associated with each of the one or more features based on a preference for the communication device to select a first RA partition of the plurality of RA partitions over a second partition of the plurality of RA partitions.

18. A communication device, the network node comprising:
processing circuitry; and
memory coupled to the processing circuitry and having instructions stored therein that are executable by the processing circuitry to cause the communication device to perform operations comprising:
determining a plurality of random access, RA, partitions configured by a network node in a communications network;
determining one or more features associated with each of the plurality of RA partitions;
determining a set of triggered features that includes one or more features the communication device intends to use to perform a RA procedure to connect to the network node;
selecting a RA partition of the plurality of RA partitions based on a priority associated with a feature of the RA partition or a priority associated with a feature of another RA partition of the plurality RA partitions; and
performing the RA procedure using the RA partition.

19.-25. (canceled)

26. The method of claim 15, wherein selecting the set of applicable RA partitions comprises selecting the set of applicable RA partitions from the plurality of RA partitions based on each RA partition of the set of applicable RA partitions comprising the set of triggered features.

27. The method of claim 15, wherein selecting the set of applicable RA partitions comprises selecting the set of applicable RA partitions from the plurality of RA partitions based on each RA partition of the set of applicable RA partitions comprising only features in the set of triggered features.
